(19) United States
(12) Patent Application Publication
(10) Pub. No.: US 2014/0358602 A1
(43) Pub. Date: Dec. 4, 2014

(54) METHODS, SYSTEMS, AND MEDIA FOR HUMAN CAPITAL ANALYSIS INCLUDING GENDER GAP

(71) Applicant: Compindex Limited, Hong Kong (HK)

(72) Inventor: Samuel Jones, Hong Kong (HK)

(73) Assignee: COMPINDEX LIMITED, CENTRAL (HK)

(21) Appl. No.: 13/938,127

(22) Filed: Jul. 9, 2013

Related U.S. Application Data
(60) Provisional application No. 61/829,945, filed on May 31, 2013.

(51) Int. Cl. G06Q 10/06

(52) U.S. Cl. CPC G06Q 10/063
USPC 705/7.11

(57) ABSTRACT

Disclosed herein are computer-based systems, media encoded with computer applications, and computer-implemented methods for identification and analysis of gender gap in human capital data comprising: a software module configured to receive data input, the data comprising human capital data pertaining to individuals of an organization; a software module configured to tag the data pertaining to individuals with a gender; a software module configured to generate a display of the data, the display comprising comparison of the data based on gender, the comparison in numeric and graphic form; and a software module configured to add comparator data to the display.

### CROSS-REFERENCE TO RELATED APPLICATIONS

This application claims the benefit of U.S. Application Ser. No. 61/829,945, filed May 31, 2013, which is hereby incorporated by reference in its entirety.

### BACKGROUND OF THE INVENTION

In the U.S. and abroad, systematic differences exist in the outcomes that men and women experience in the labor market. These differences are seen, for example, in the percentages of men and women in the labor force, the types of occupations they choose, and their relative incomes, hourly wages, or salaries.

### SUMMARY OF THE INVENTION

Traditional human resource management technologies fail to provide adequate tools to identify and address gender disparities within organizations. In contrast, advantages of the systems, media, and methods described herein include, by way of non-limiting examples, providing the ability to utilize human capital data from a wide variety of sources, providing the ability to conduct analysis and transform human capital data into a visual display of gender disparities where they exist, and providing the ability to conduct detailed gender disparity benchmarking against a range of user-selectable comparators.

In one aspect, disclosed herein are non-transitory computer-readable storage media encoded with a computer program including instructions executable by a processor to create an application comprising: a software module configured to receive data input, the data comprising human capital data pertaining to individuals of an organization; a software module configured to tag the data pertaining to individuals with at least one diversity parameter; a software module configured to generate a display of the data, the display comprising comparison of the data based on the at least one diversity parameter, the comparison in numeric and graphic form; and a software module configured to add comparator data to the display. In some embodiments, the at least one diversity parameter is selected from: gender, age, ethnicity, nationality, religion or belief, sexual orientation, veteran status, marriage or civil partnership status, disability, part time/full time workers, caregiver status, pregnancy/maternity status, gender assignment, criminal conviction status, and trade union membership. In further embodiments, the at least one diversity parameter is gender. In some embodiments, the human capital data comprises one or more of: human resources identifier, title, ethnicity, education, age, location, organization division or unit, year hired, entry point to organization, year left, promotion information, fixed compensation, bonus compensation, performance information, and maternity leave information. In further embodiments, the human capital data comprises compensation data. In some embodiments, the data input is provided by upload of an output from a human capital management application. In further embodiments, the output is in a format selected from: a database, a spreadsheet, comma-separated values, and tab-separated values. In some embodiments, the data input is provided by manual data entry. In some embodiments, the display is based on data from one or more particular offices, one or more particular businesses, one or more particular years, or a combination thereof. In some embodiments, the display of the data includes comparison of the data based on the at least one diversity parameter at each level within the organization. In some embodiments, the display of the data includes comparison of the data based on the at least one diversity parameter and identifies one or more of: leavers, promotions, new hires, or combinations thereof. In some embodiments, the comparison of the data based the at least one diversity parameter is presented in a numeric form selected from: a ratio, percentages for each gender, total numbers for each gender, or a combination thereof. In some embodiments, the comparison of the data based the at least one diversity parameter is presented in a graphic form selected from: a graph, a chart, a table, or a combination thereof. In some embodiments, the display of the data demonstrates diversity inequalities where present. In some embodiments, the display of the data comprises a heat map of diversity differences. In some embodiments, the comparator data comprises a peer group. In further embodiments, the peer group is user-selectable. In some embodiments, the comparator data comprises a market leader. In some embodiments, the application is a web application. In further embodiments, the web application is implemented as software-as-a-service.

In another aspect, disclosed herein are computer-implemented systems comprising: a digital processing device comprising an operating system configured to perform executable instructions and a memory device; a computer program including instructions executable by the digital processing device to create an application comprising: a software module configured to receive data input, the data comprising human capital data pertaining to individuals of an organization; a software module configured to tag the data pertaining to individuals with at least one diversity parameter; a software module configured to generate a display of the data, the display comprising comparison of the data based on the at least one diversity parameter, the comparison in numeric and graphic form; and a software module configured to add comparator data to the display. In some embodiments, the at least one diversity parameter is selected from: gender, age, ethnicity, nationality, religion or belief, sexual orientation, veteran status, marriage or civil partnership status, disability, part time/full time workers, caregiver status, pregnancy/maternity status, gender assignment, criminal conviction status, and trade union membership. In further embodiments, the at least one diversity parameter is gender. In some embodiments, the human capital data comprises one or more of: human resources identifier, title, ethnicity, education, age, location, organization division or unit, year hired, entry point to organization, year left, promotion information, fixed compensation, bonus compensation, performance information, and maternity leave information.

In another aspect, disclosed herein are computer-implemented systems comprising: a digital processing device comprising an operating system configured to perform executable instructions and a memory device; a computer program including instructions executable by the digital processing device to create an application comprising: a software module configured to receive data input, the data comprising human capital data pertaining to individuals of an organization; a software module configured to tag the data pertaining to individuals with a gender; a software module configured to generate a display of the data, the display comprising comparison of the data based on gender, the comparison in numeric and graphic form; and a software module configured to add comparator data to the display. In some embodiments, the human capital data comprises one or more of: human resources identifier, title, ethnicity, education, age, location, organization division or unit, year hired, entry point to organization, year left, promotion information, fixed compensation, bonus compensation, performance information, and maternity leave information. In further embodiments, the human capital data comprises compensation data. In some embodiments, the data input is provided by upload of an output from a human capital management application. In further embodiments, the output is in a format selected from: a database, a spreadsheet, comma-separated values, and tab-separated values. In other embodiments, the data input is provided by manual data entry. In some embodiments, the display is based on data from one or more particular offices, one or more particular businesses, one or more particular years, or a combination thereof. In some embodiments, the display of the data includes comparison of the data based on gender at each level within the organization. In some embodiments, the display of the data includes comparison of the data based on gender that identifies one or more of: leavers, promotions, new hires, or combinations thereof. In some embodiments, the comparison of the data based on gender is presented in a numeric form selected from: a ratio, percentages for each gender, total numbers for each gender, or a combination thereof. In some embodiments, the comparison of the data based on gender is presented in a graphic form selected from: a graph, a chart, a table, or a combination thereof. In some embodiments, the display of the data demonstrates gender inequalities where present. In some embodiments, the display of the data comprises a heat map of gender differences. In some embodiments, the comparator data comprises a peer group. In further embodiments, the peer group is user-selectable. In some embodiments, the comparator data comprises a market leader. In some embodiments, the application is a web application. In further embodiments, the web application is implemented as software-as-a-service.

In another aspect, disclosed herein are non-transitory computer-readable storage media encoded with a computer program including instructions executable by a processor to create an application comprising: a software module configured to receive data input, the data comprising human capital data pertaining to individuals of an organization; a software module configured to tag the data pertaining to individuals with a gender; a software module configured to generate a display of the data, the display comprising comparison of the data based on gender, the comparison in numeric and graphic form; and a software module configured to add comparator data to the display. In some embodiments, the human capital data comprises one or more of: human resources identifier, title, ethnicity, education, age, location, organization division or unit, year hired, entry point to organization, year left, promotion information, fixed compensation, bonus compensation, performance information, and maternity leave information. In further embodiments, the human capital data comprises compensation data. In some embodiments, the data input is provided by upload of an output from a human capital management application. In further embodiments, the output is in a format selected from: a database, a spreadsheet, comma-separated values, and tab-separated values. In other embodiments, the data input is provided by manual data entry. In some embodiments, the display is based on data from one or more particular offices, one or more particular businesses, one or more particular years, or a combination thereof. In some embodiments, the display of the data includes comparison of the data based on gender at each level within the organization. In some embodiments, the display of the data includes comparison of the data based on gender that identifies one or more of: leavers, promotions, new hires, or combinations thereof. In some embodiments, the comparison of the data based on gender is presented in a numeric form selected from: a ratio, percentages for each gender, total numbers for each gender, or a combination thereof. In some embodiments, the comparison of the data based on gender is presented in a graphic form selected from: a graph, a chart, a table, or a combination thereof. In some embodiments, the display of the data demonstrates gender inequalities where present. In some embodiments, the display of the data comprises a heat map of gender differences. In some embodiments, the comparator data comprises a peer group. In further embodiments, the peer group is user-selectable. In some embodiments, the comparator data comprises a market leader. In some embodiments, the application is a web application. In further embodiments, the web application is implemented as software-as-a-service.

In another aspect, disclosed herein are computer-implemented methods of measuring gender inequalities in human capital data comprising: receiving, by a computer, data input, the data comprising human capital data pertaining to individuals of an organization; tagging, by the computer, the data pertaining to individuals with a gender; generating, by the computer, a display of the data, the display comprising comparison of the data based on gender, the comparison in numeric and graphic form; and adding, by the computer, comparator data to the display. In some embodiments, the human capital data comprises one or more of: human resources identifier, title, ethnicity, education, age, location, organization division or unit, year hired, entry point to organization, year left, promotion information, fixed compensation, bonus compensation, performance information, and maternity leave information. In further embodiments, the human capital data comprises compensation data. In some embodiments, the data input is provided by upload of an output from a human capital management application. In further embodiments, the output is in a format selected from: a database, a spreadsheet, comma-separated values, and tab-separated values. In other embodiments, the data input is provided by manual data entry. In some embodiments, the display is based on data from one or more particular offices, one or more particular businesses, one or more particular years, or a combination thereof. In some embodiments, the display of the data includes comparison of the data based on gender at each level within the organization. In some embodiments, the display of the data includes comparison of the data based on gender that identifies one or more of: leavers, promotions, new hires, or combinations thereof. In some embodiments, the comparison of the data based on gender is presented in a numeric form selected from: a ratio, percentages for each gender, total numbers for each gender, or a combination thereof. In some embodiments, the comparison of the data based on gender is presented in a graphic form selected from: a graph, a chart, a table, or a combination thereof. In some embodiments, the display of the data demonstrates gender inequalities where present. In some embodiments, the display of the data comprises a heat map of gender differences. In some embodiments, the comparator data comprises a peer group. In further embodiments, the peer group is user-selectable. In some embodiments, the comparator data comprises a market leader. In some embodiments, the application is a web application. In further embodiments, the web application is implemented as software-as-a-service.

In another aspect, disclosed herein are non-transitory computer-readable storage media encoded with an interactive heat map, the heat map displaying a summary of human capital data for an organization, the human capital data tagged with at least one diversity parameter and partitioned into a hierarchical organization, wherein the hierarchical organization is ascended and descended via user interaction with the interactive heat map, provided that the heat map displays a human capital difference based on the at least one diversity parameter at each level of the hierarchical organization. In some embodiments, the heat map is generated by: receiving, by a computer, data input, the data comprising human capital data pertaining to individuals of an organization; tagging, by the computer, the human capital data pertaining to individuals with at least one diversity parameter; and generating, by the computer, a heat map display of the human capital data, the heat map comprising comparison of the data based on the at least one diversity parameter, the comparison numeric and color-based. In further embodiments, the heat map further comprises comparator data from one or more peer organizations or a leader organization.

In another aspect, disclosed herein are non-transitory computer-readable storage media encoded with a diversity score card for an organization, the diversity score card displaying a summary of human capital data for the organization, the human capital data tagged with at least one diversity parameter, wherein the diversity score card is configurable to be partitioned by location, unit of the organization, or level of individual within the organization, provided that the diversity score card displays at least one human capital difference based on the at least one diversity parameter for each partition including a comparison to human capital data of one or more comparator organizations. In some embodiments, the diversity score card is generated by: receiving, by a computer, data input, the data comprising human capital data pertaining to individuals of an organization; tagging, by the computer, the human capital data pertaining to individuals with at least one diversity parameter; and generating, by the computer, a score card display of the human capital data, the score card comprising comparison of the human capital data based on the at least one diversity parameter, the comparison comprising a percentage difference and a rank based on comparison to human capital data of one or more comparator organizations. In further embodiments, the one or more comparator organizations comprise a peer organizations or a leader organization.

### BRIEF DESCRIPTION OF THE DRAWINGS

FIG. 1 shows a non-limiting example of a human capital data display; in this case, a display demonstrating gender differences across an organization and at each level within the organization.

FIGS. 2-5 show non-limiting examples of a human capital data display demonstrating gender differences across an organization and at each level within the organization; in these cases, the display is based on a user-selectable data set configurable with regard to location, division/unit, peer group (as comparator), and year.

FIG. 6 shows a non-limiting example of a human capital data display demonstrating gender differences across an organization and at each level within the organization; in this case, a display where the data pertaining to each level within the organization includes an interactive element providing more detailed information upon a user interaction.

FIGS. 7 and 8 show non-limiting examples of a human capital data display demonstrating gender differences across an organization and at each level within the organization; in these cases, the display includes comparison to a peer group of organizations or an industry leader organization.

FIGS. 9-11 show non-limiting examples of a human capital data display demonstrating gender differences across an organization and at each level within the organization; in these cases, the display includes identification of a user-selectable subset of data configurable with regard to leavers, promotions, and new hires.

FIG. 12 shows a non-limiting example of a human capital data display; in this case, a display demonstrating the overall gender profile of an organization.

FIGS. 13 and 14 show non-limiting examples of a human capital data display demonstrating the overall gender profile of an organization; in these cases, the display includes comparison to a peer group of organizations or an industry leader organization.

FIGS. 15-17 show non-limiting examples of a human capital data display demonstrating the overall gender profile of an organization; in these cases, the display includes identification of a user-selectable subset of data configurable with regard to leavers, promotions, and new hires.

FIG. 18 shows a non-limiting example of a human capital data display; in this case, a display demonstrating the overall gender pay gap of an organization.

FIGS. 19 and 20 show non-limiting examples of a human capital data display demonstrating the overall gender pay gap of an organization; in these cases, the display includes comparison to a peer group of organizations or an industry leader organization.

FIGS. 21-23 show non-limiting examples of a human capital data display demonstrating the overall gender pay gap of an organization; in these cases, the display includes identification of a user-selectable subset of data configurable with regard to leavers, promotions, and new hires.

FIGS. 24-26 show non-limiting examples of a human capital data display; in these cases, the display includes a heat map of gender pay differences across divisions/units of the organization, levels within the organization, and locations in which the organization operates.

FIG. 27 shows a non-limiting example of a human capital data display; in these cases, the display includes a score card of human capital differences for the organization in general and across levels within the organization.

FIG. 28 shows a non-limiting example of a schematic diagram; in this case, a schematic diagram illustrating how the software described herein shares human capital and diversity benchmarking data across an industry via a secure cloud.

### DETAILED DESCRIPTION OF THE INVENTION

Described herein, in certain embodiments, are non-transitory computer-readable storage media encoded with a computer program including instructions executable by a processor to create an application comprising: a software module configured to receive data input, the data comprising human capital data pertaining to individuals of an organization; a software module configured to tag the data pertaining to individuals with at least one diversity parameter; a software module configured to generate a display of the data, the display comprising comparison of the data based on the at least one diversity parameter, the comparison in numeric and graphic form; and a software module configured to add comparator data to the display.

Also described herein, in certain embodiments, are computer-implemented systems comprising: a digital processing device comprising an operating system configured to perform executable instructions and a memory device; a computer program including instructions executable by the digital processing device to create an application comprising: a software module configured to receive data input, the data comprising human capital data pertaining to individuals of an organization; a software module configured to tag the data pertaining to individuals with at least one diversity parameter; a software module configured to generate a display of the data, the display comprising comparison of the data based on the at least one diversity parameter, the comparison in numeric and graphic form; and a software module configured to add comparator data to the display.

Also described herein, in certain embodiments, are computer-implemented systems comprising: a digital processing device comprising an operating system configured to perform executable instructions and a memory device; a computer program including instructions executable by the digital processing device to create an application comprising: a software module configured to receive data input, the data comprising human capital data pertaining to individuals of an organization; a software module configured to tag the data pertaining to individuals with a gender; a software module configured to generate a display of the data, the display comprising comparison of the data based on gender, the comparison in numeric and graphic form; and a software module configured to add comparator data to the display.

Also described herein, in certain embodiments, are non-transitory computer-readable storage media encoded with a computer program including instructions executable by a processor to create an application comprising: a software module configured to receive data input, the data comprising human capital data pertaining to individuals of an organization; a software module configured to tag the data pertaining to individuals with a gender; a software module configured to generate a display of the data, the display comprising comparison of the data based on gender, the comparison in numeric and graphic form; and a software module configured to add comparator data to the display.

Also described herein, in certain embodiments, are computer-implemented methods of measuring gender inequalities in human capital data comprising: receiving, by a computer, data input, the data comprising human capital data pertaining to individuals of an organization; tagging, by the computer, the data pertaining to individuals with a gender; generating, by the computer, a display of the data, the display comprising comparison of the data based on gender, the comparison in numeric and graphic form; and adding, by the computer, comparator data to the display.

Also described herein, in certain embodiments, are non-transitory computer-readable storage media encoded with an interactive heat map, the heat map displaying a summary of human capital data for an organization, the human capital data tagged with at least one diversity parameter and partitioned into a hierarchical organization, wherein the hierarchical organization is ascended and descended via user interaction with the interactive heat map, provided that the heat map displays a human capital difference based on the at least one diversity parameter at each level of the hierarchical organization.

Also described herein, in certain embodiments, are non-transitory computer-readable storage media encoded with a diversity score card for an organization, the diversity score card displaying a summary of human capital data for the organization, the human capital data tagged with at least one diversity parameter, wherein the diversity score card is configurable to be partitioned by location, unit of the organization, or level of individual within the organization, provided that the diversity score card displays at least one human capital difference based on the at least one diversity parameter for each partition including a comparison to human capital data of one or more comparator organizations.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Human Capital Data

In some embodiments, the systems, media, and methods described herein utilize human capital data. In further embodiments, the human capital data is suitably aggregate data. In other embodiments, the human capital data is suitably individual data. As used herein in some embodiments, “human capital” refers to the collection of competencies, knowledge, and attributes, including creativity, possessed by the individuals of an organization and embodied in the ability to perform labor so as to produce economic value. In further embodiments, the human capital data pertains to individuals. In still further embodiments, the human capital data pertains to individuals of an organization. The human capital data suitably pertains to individuals of a wide array of organizations. By way of non-limiting examples, the human capital data suitably pertains to individuals of a company, business entity, trade or professional organization, governmental agency, military force, non-profit organization, non-governmental organization, political organization, research organization, community, school or university, club, and the like.

Many types of human capital data are suitable. In some embodiments, suitable human capital data includes human resources identifiers. In further embodiments, human resources identifiers include numeric and alphanumeric identifiers used by human resource departments or software to refer to individuals. In some embodiments, suitable human capital data includes demographic information. In further embodiments, demographic information includes ethnicity, education, age, location, marital status, children, and the like. In some embodiments, suitable human capital data includes business information. In further embodiments, business information includes title, business division or unit, year hired, entry point to organization, year left (if any), maternity leave information, and the like. In further embodiments, business information includes compensation information such as promotion information, fixed compensation, bonus compensation, and the like. In further embodiments, business information includes performance information such as ratings, scores, reviews, evaluations, and the like.

In some embodiments, suitable human capital data includes data pertaining to analysis of bases of diversity other than gender described herein. In further embodiments, suitable human capital data includes, by way of non-limiting examples, country of hire, assignment country, employee level, business unit, specific team/function, performance ranking, promotion dates, highest education level achieved, university attended, start date, leave date and reason for leaving (e.g., redundancy, termination, resignation, etc.), maternity returner and date of return, flexible work contract (i.e., condensed hours, work from home, etc.), graduate or lateral hire, line manager status, high potential program attendees, mentoring/sponsorship program involvement, formal performance management, membership in an internal diversity network, and the like.

In some embodiments, the systems, media, and methods described herein include a software module configured to receive input of human capital data. In further embodiments, the data input is provided by manual data entry. In various embodiments, manual data entry is achieved, for example, by typing, pointing device, touchscreen, voice recognition, and the like. In other embodiments, the data input is provided by upload of an output from a human capital management application. In further embodiments, the data input is provided by upload of an output from human capital management applications by, for example, PeopleSoft, Workday, SAP, Infor, Accenture, and the like. In still further embodiments, the data input is provided in a format such as a database, a spreadsheet, comma-separated values (CSV), and tab-separated values (TSV), Extensible Markup Language (XML), and the like.

### Gender Tagging

In some embodiments, the systems, media, and methods described herein utilize data tagging. As used herein in some embodiments, “tagging” refers to associating a piece of information with metadata to facilitate efficient organization, filtering, browsing, or searching. In further embodiments, the tagging is gender tagging and the metadata associates the information with a gender (e.g., male, female, decline to state, etc.). In still further embodiments, gender tagging facilitates analysis, filtering, searching, identification, and quantification of discrepancies, disparities, and inequalities in human capital data based on gender.

Gender tagging is suitably achieved in a variety of ways. In some embodiments, gender tagging is achieved manually. In further embodiments, a human analyst associates human capital data with the gender of the individual to which it pertains. In various embodiments, a human analyst utilizes cues for name, human resources identifier, maternity information, and the like to tag data based on gender.

In other embodiments, software associates human capital data with the gender of the individual to which it pertains. In further embodiments, the systems, media, and methods described herein include a software module configured to tag human capital data with a gender. In various embodiments, a software module utilizes cross-references to name, human resources identifier, maternity information, and the like to tag data based on gender.

### Data Display

In some embodiments, the systems, media, and methods described herein include a data display, or use of the same. In further embodiments, a data display presents human capital data. In still further embodiments, a data display presents a comparison of human capital data based on gender. In various embodiments, a comparison of human capital data based on gender is suitably presented in narrative form (e.g., text descriptions, etc.), numeric form (e.g., scores, rankings, ratings, percentages, etc.), graphic form (e.g., charts, tables, graphs, heat maps, etc.), or combinations thereof.

In some embodiments, a data display is based on a subset of the human capital data available. For example, in various further embodiments, a data display is based on application of a filter to the human capital data available. In some embodiments, a data display is based on a user configurable subset of the human capital data. In further embodiments, a data display presents a subset of the human capital data filtered based on time. For example, in particular embodiments, a data display presents human capital data for one or more particular years, one or more particular quarters, one or more particular months, and the like. In further embodiments, a data display presents a subset of the human capital data filtered based on location. For example, in particular embodiments, a data display presents human capital data for one or more particular countries, one or more particular states, one or more particular cities, one or more particular offices, one or more particular regions, one or more particular businesses, one or more particular divisions or units, and the like. In some embodiments, a data display presents a subset of the human capital data filtered based on human resource metrics. For example, in particular embodiments, a data display presents human capital data for leavers, promotions, new hires, and the like.

In some embodiments, a data display presents human capital data for all levels within the organization simultaneously. In other embodiments, a data display presents human capital data for one or more levels within the organization. In further embodiments, a data display presents distinct human capital data for levels within an organization including, by way of non-limiting examples, intern, analyst, associate, vice president, director, managing director, senior managing director, and c-level. In some embodiments, the organizational levels are predetermined and preset with the software. In other embodiments, the organizational levels are user-configurable.

In some embodiments, the systems, media, and methods described herein include a software module configured to generate a display of the data the display comprising comparison of the data based on gender, the comparison in numeric and graphic form.

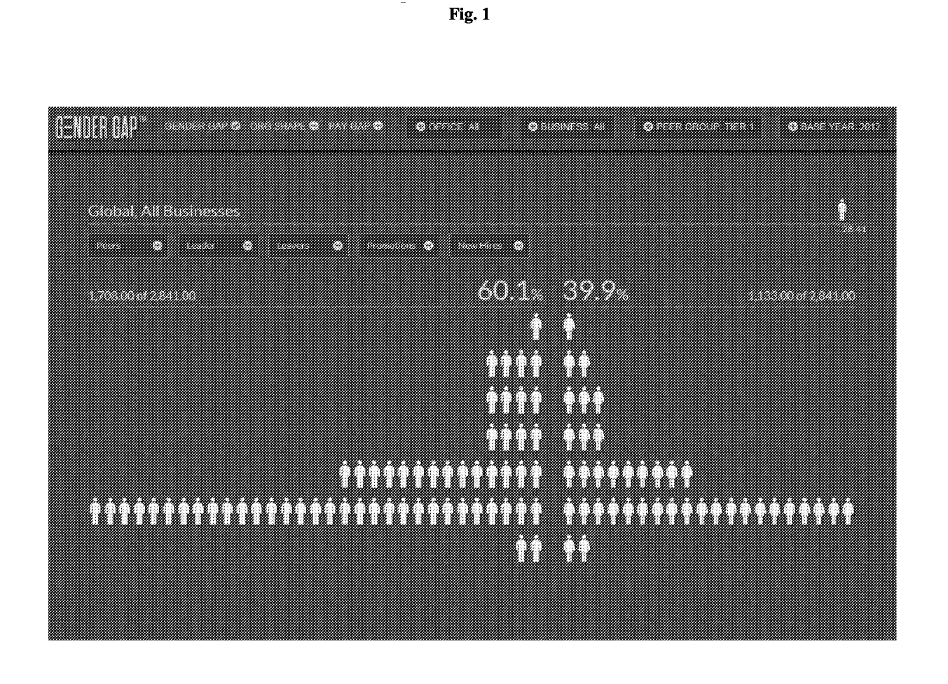

Referring to FIG. 1, in a particular embodiment, a human capital data display demonstrates gender differences within an organization and at each level within the organization. The data set in this embodiment represents all offices and all businesses within the organization for the year 2012. The male and female individuals are also summarized numerically as ratios (e.g., 1,708.00 of 2,841.00 and 1,133.00 of 2,841.00) as well as percentages (e.g., 60.1% and 39.9%). User interface elements are available, which provide access to comparator data (e.g., peers and leader). User interface elements are also available, which provide access to filters, which identify subsets of leavers, promoted individuals, and new hires within the gender-based comparison.

For each level within the organization, the number of male individuals are displayed graphically on the left and the number of female individuals are displayed graphically on the right.

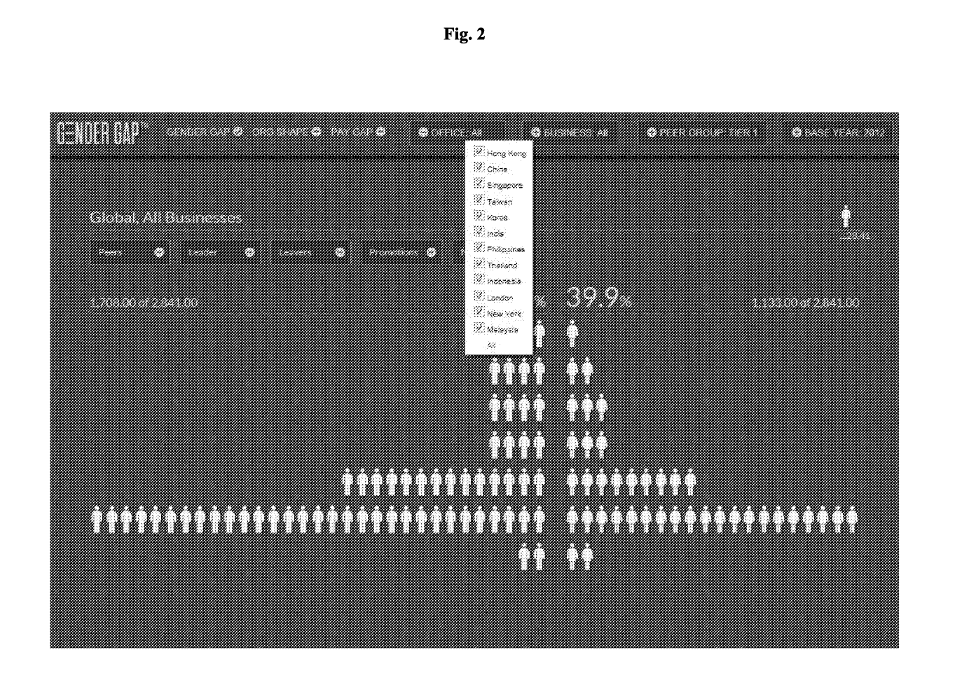

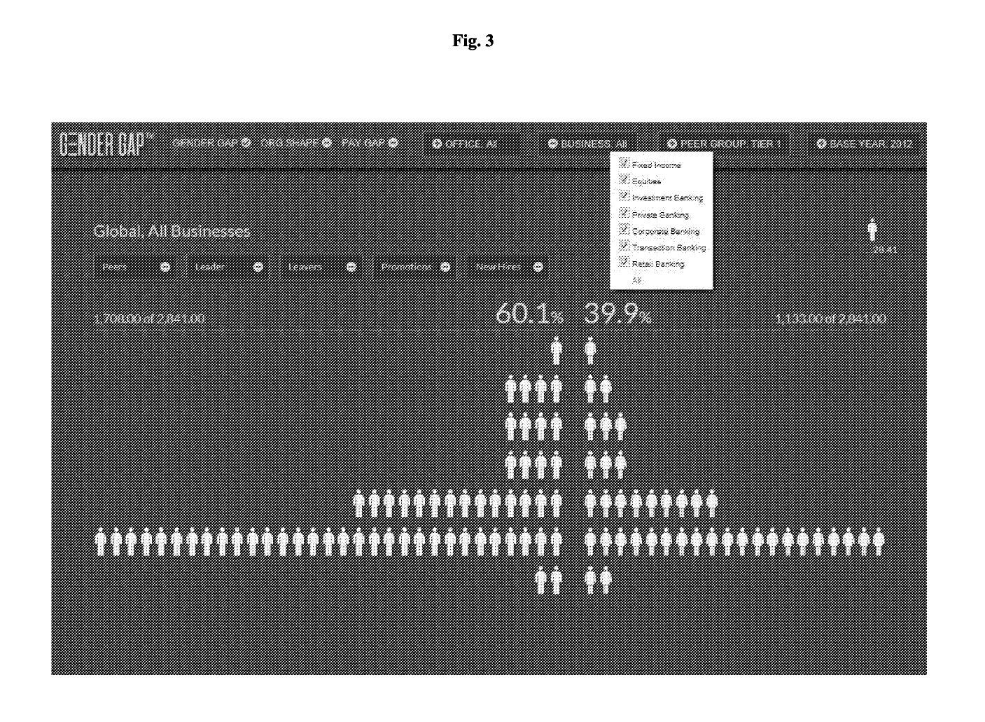

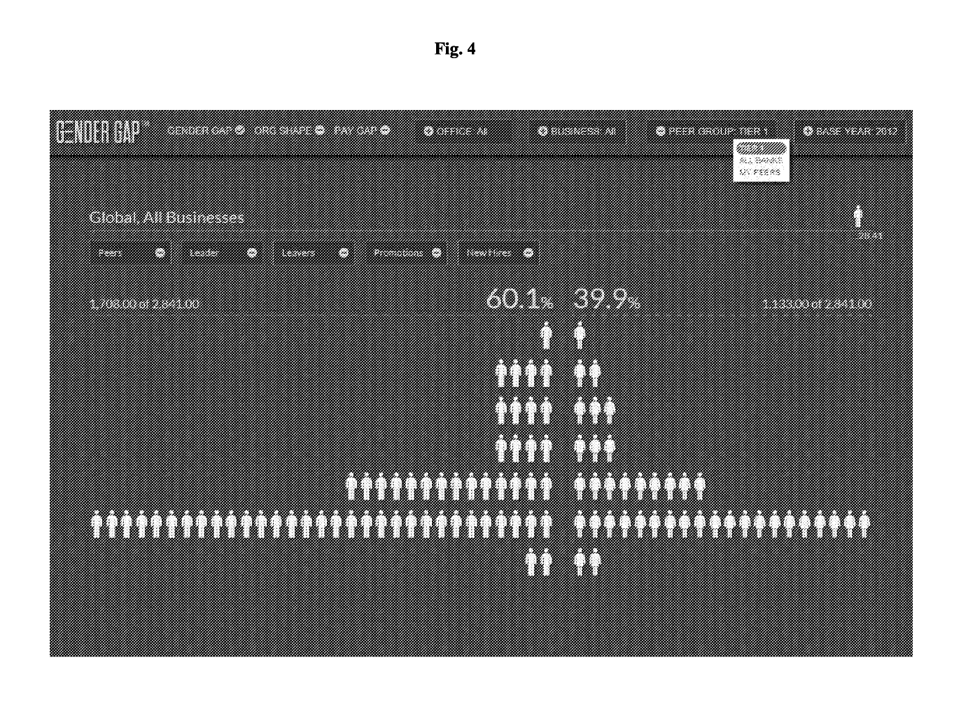

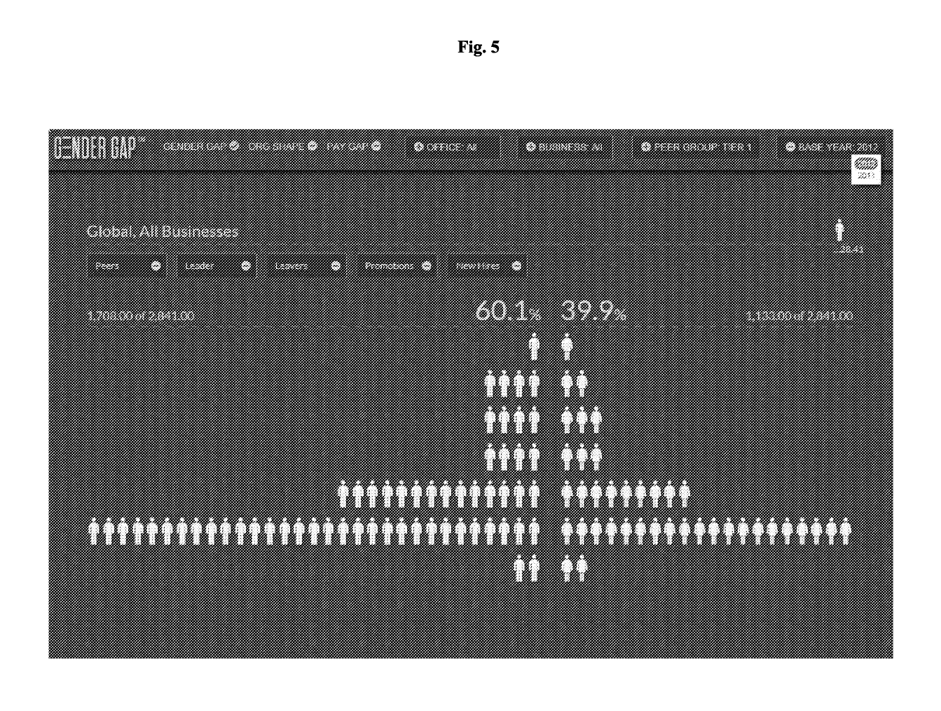

Referring to FIGS. 2-5, in particular embodiments, a human capital data display includes user interface elements allowing a user to configure the human capital data summarized by the display. In these embodiments, a user optionally configures the display to include data from one or more offices (see FIG. 2), one or more businesses (see FIG. 3), one or more peer group comparators (see FIG. 4), and one or more periods of time such as years (see FIG. 5).

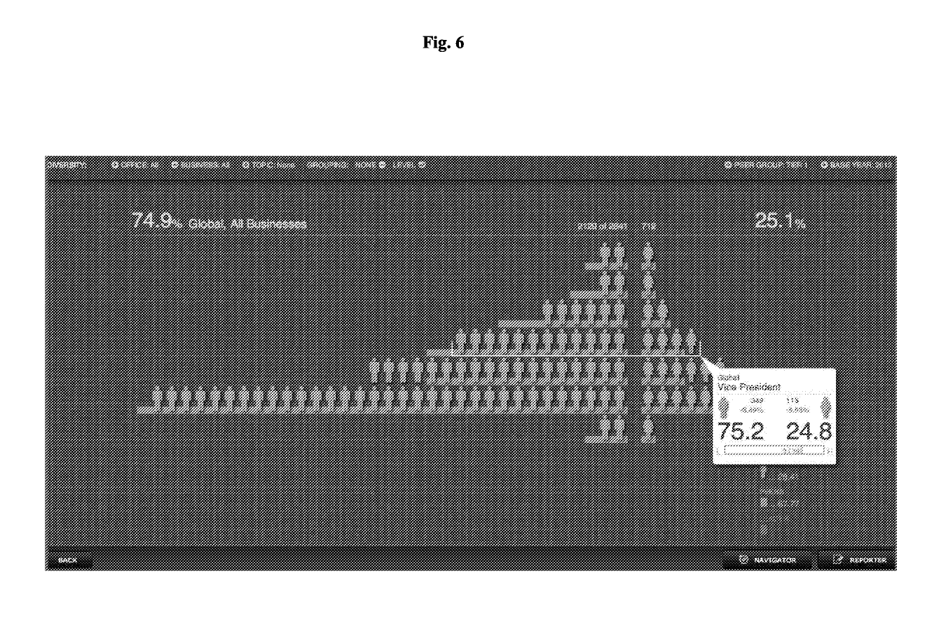

Referring to FIG. 6, in a particular embodiment, a human capital data display includes an interactive element, which provides more detailed information upon a user interaction (e.g., touch, click, roll-over, etc.). In this embodiment, an interactive pop-up element provides further percentages and raw numbers for a gender comparison of individuals at the vice president level within an organization.

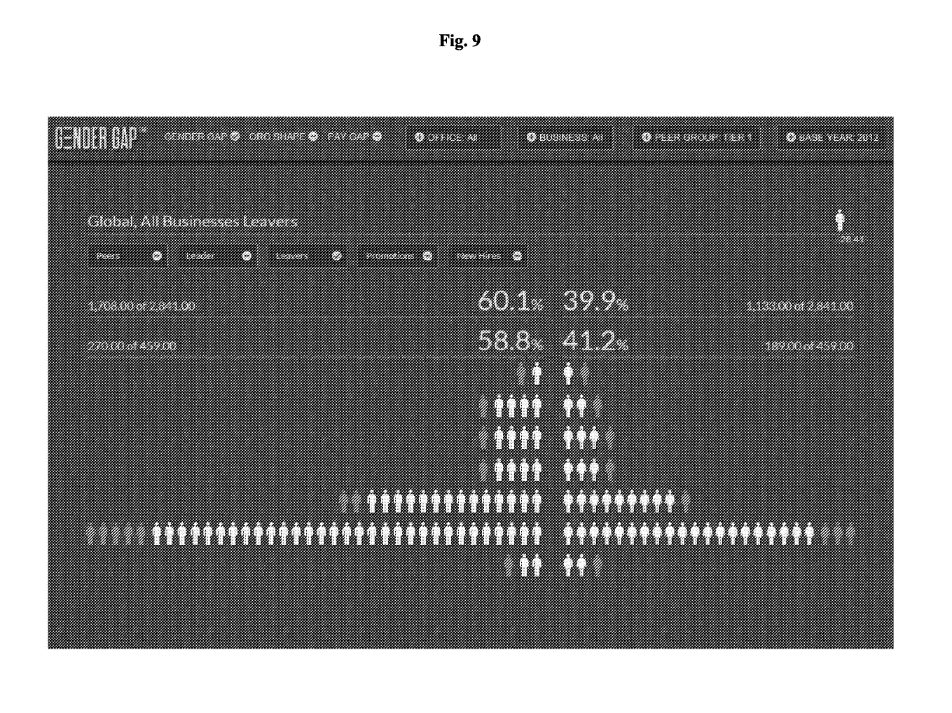

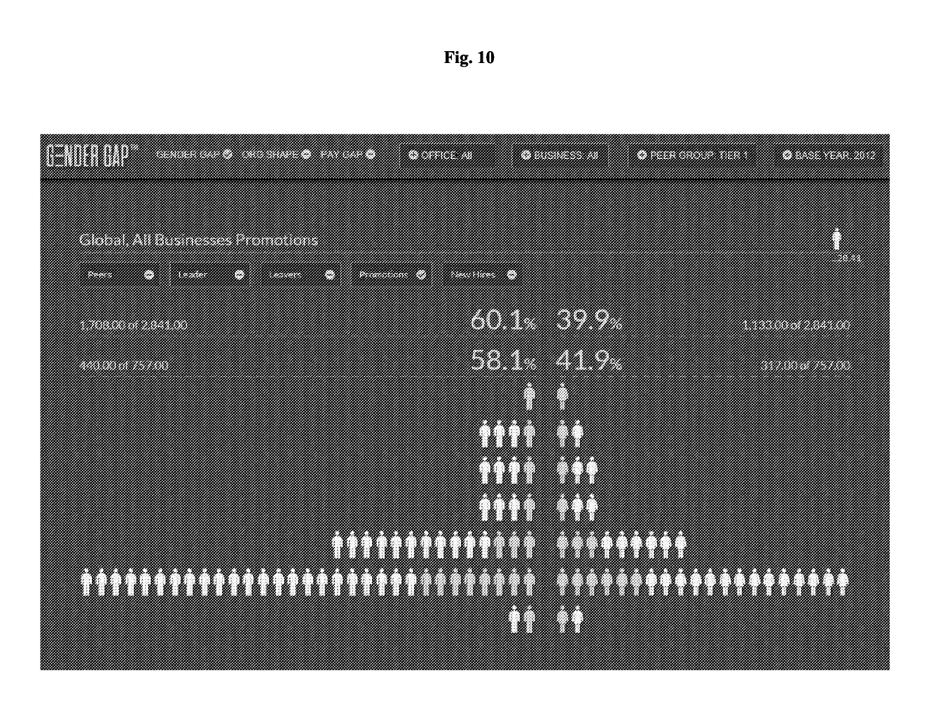

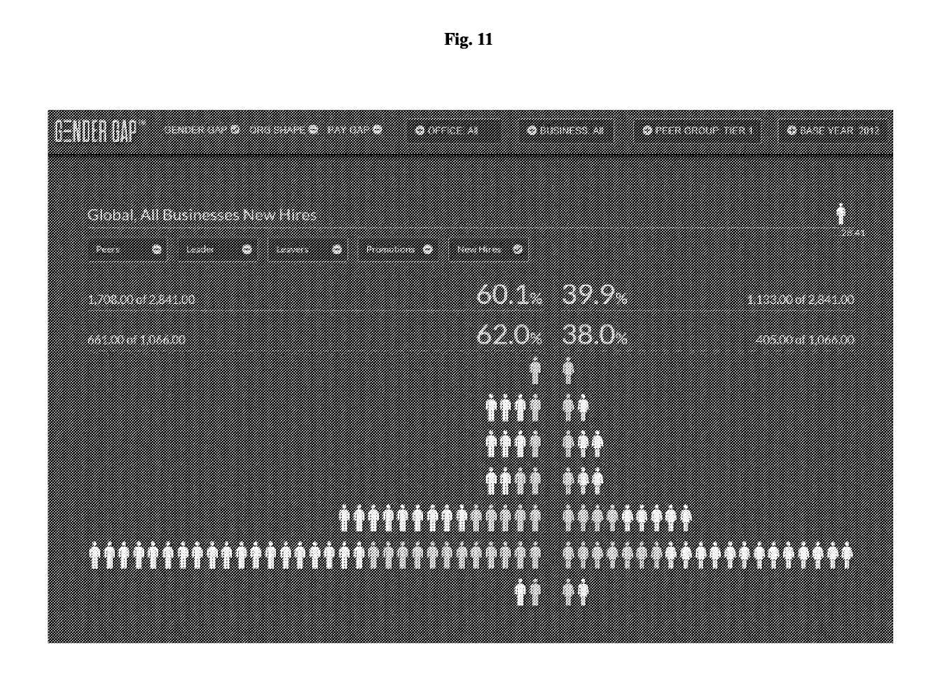

Referring to FIGS. 9-11, in particular embodiments, a human capital data display presents a gender-based comparison that includes identification of a user-selectable subset of data. In these embodiments, the display optionally identifies the leavers (see FIG. 9), promoted individuals (see FIG. 10), and new hires (see FIG. 11), for each gender within the compared data. In these embodiments, the subsets are identified graphically at each level of the organization and numerically via raw numbers and percentages.

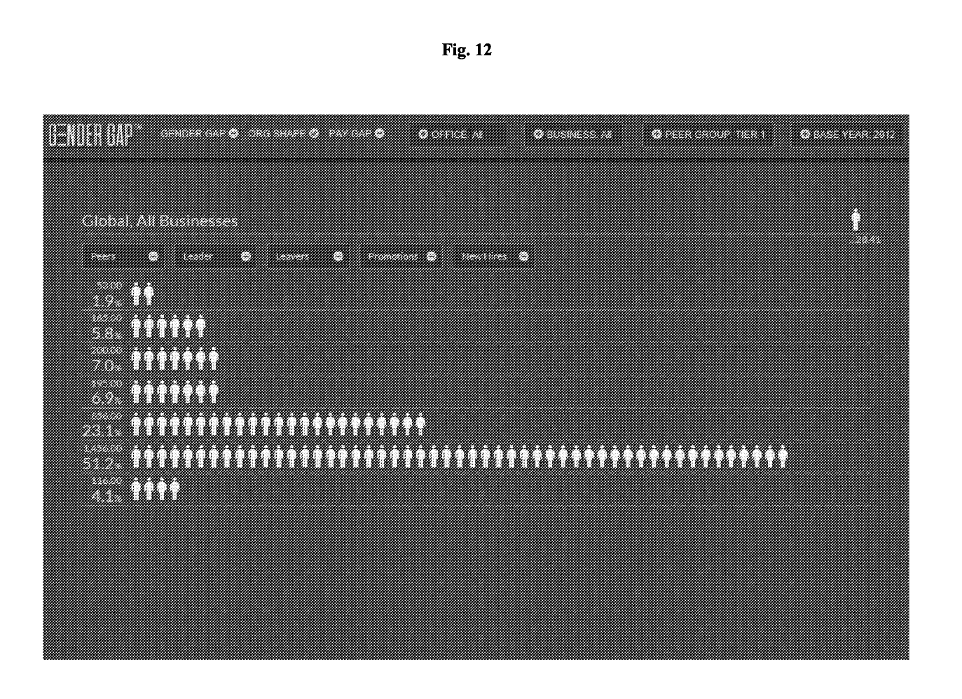

Referring to FIG. 12, in a particular embodiment, a human capital data display presents an overall gender profile of an organization. In this embodiment, a comparison of the number of male and female individuals is presented at each level within the organization. Gender disparities are identified and quantified via raw numbers and percentages for each level. This particular embodiment summarizes data for all offices and all businesses within the organization for the year 2012.

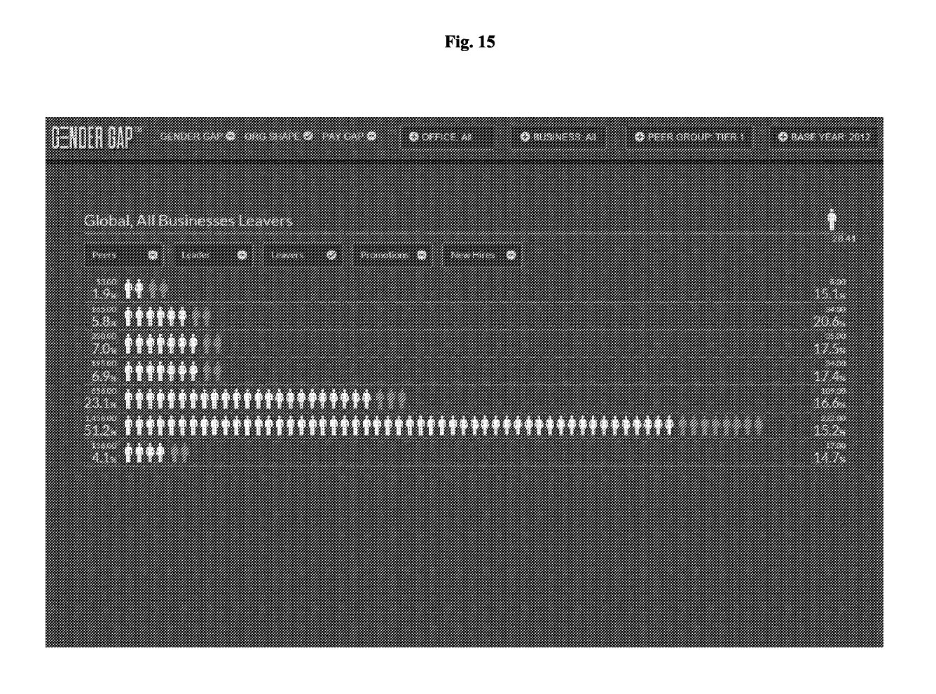

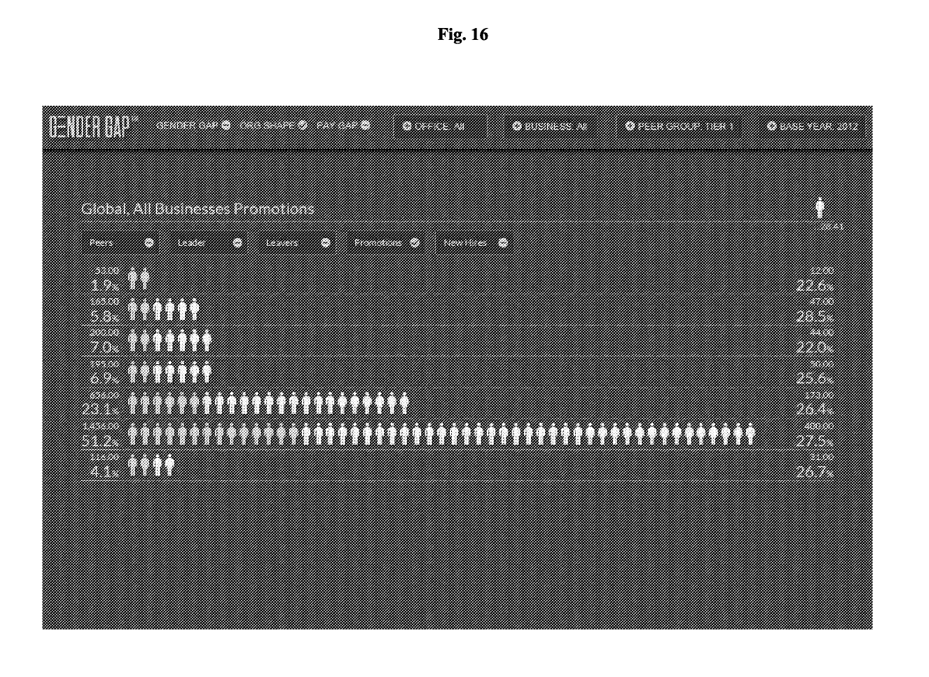

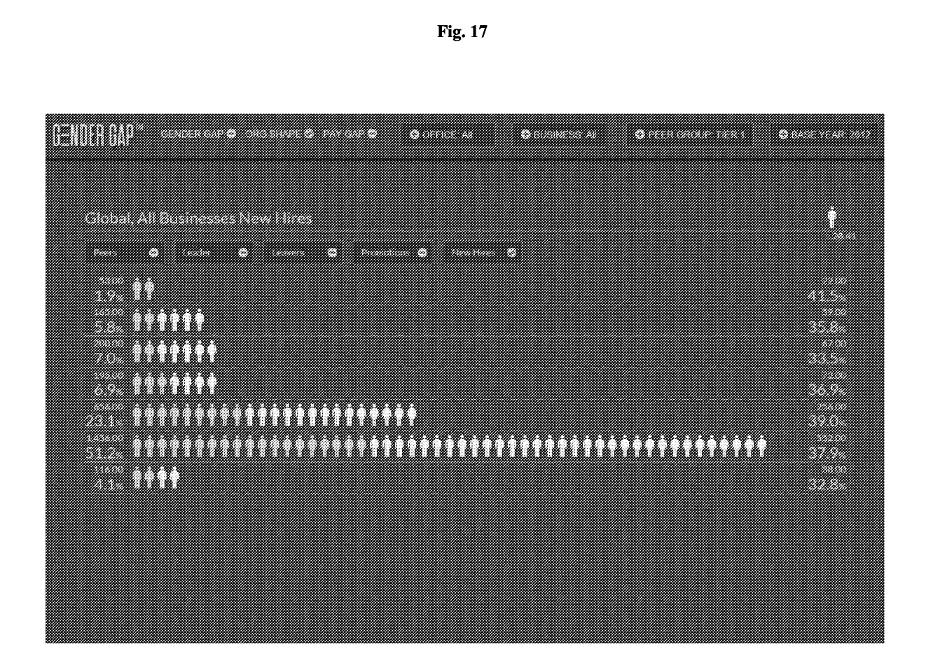

Referring to FIGS. 15-17, in particular embodiments, a human capital data display presents an overall gender profile of an organization that includes identification of a user-selectable subset of data. In these embodiments, the display optionally identifies the leavers (see FIG. 15), promoted individuals (see FIG. 16), and new hires (see FIG. 17), for each gender within the compared data. In these embodiments, the subsets are identified graphically at each level of the organization and numerically via raw numbers and percentages.

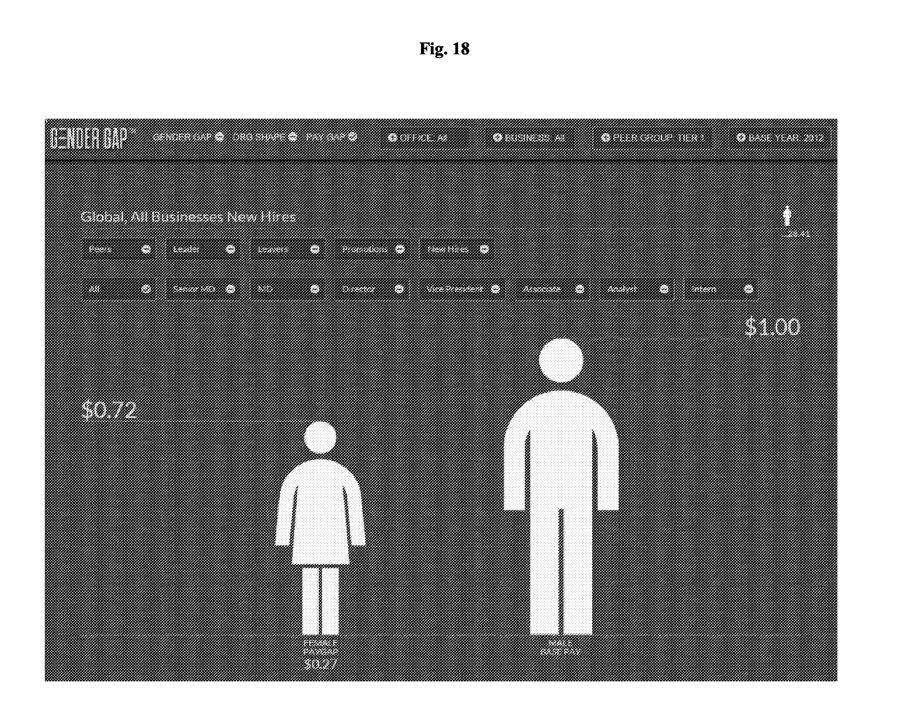

Referring to FIG. 18, in a particular embodiment, a human capital data display summarizes overall gender pay gap. In this embodiment, the pay gap is presented graphically by way of icon size differences as well as numerically as dollar values.

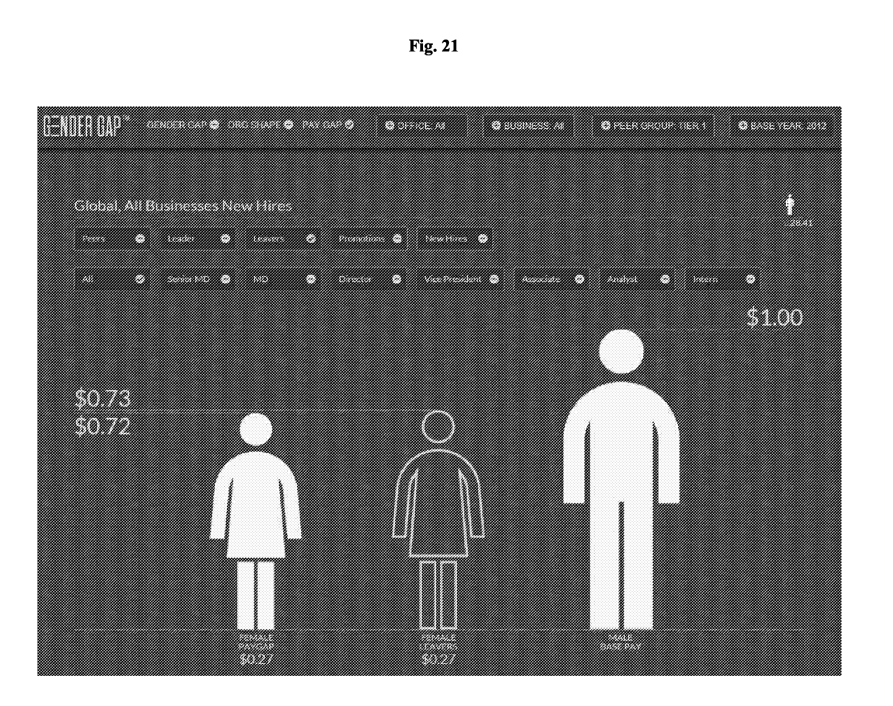

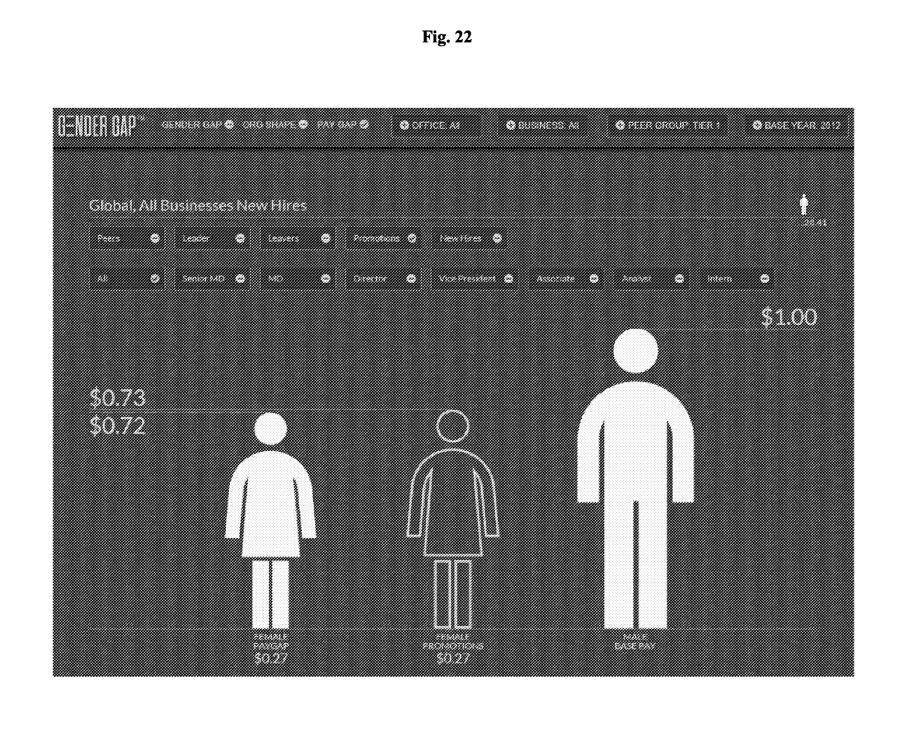

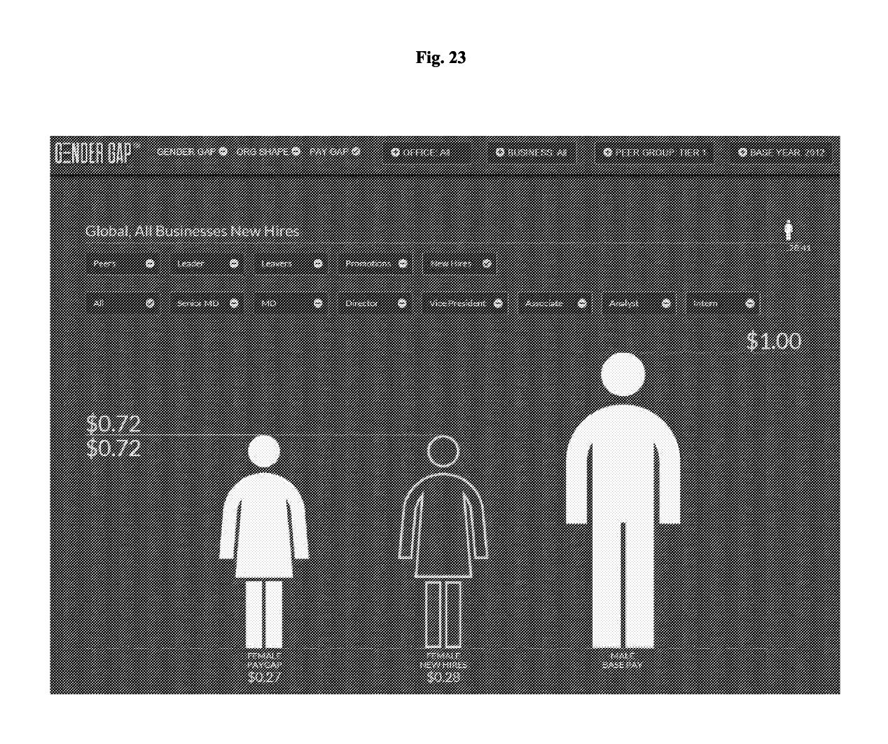

Referring to FIGS. 21-23, in particular embodiments, a human capital data display summarizes the gender pay gap of an organization that includes identification of a user-selectable subset of data. In these embodiments, the display optionally identifies a pay gap for leavers (see FIG. 21), promoted individuals (see FIG. 22), and new hires (see FIG. 23). The pay gaps are identified graphically by way of icon size differences as well as numerically as dollar values.

In some embodiments, the display of the data comprises a heat map of gender differences. As used herein in some embodiments, “heat map” refers to a graphical representation of data where individual values contained in a matrix are represented as colors. In further embodiments, a heat map comprises a choropleth map. As used herein in some embodiments, “choropleth map” refers to a thematic map in which areas are shaded or patterned in proportion to the measurement of the statistical variable being displayed on the map.

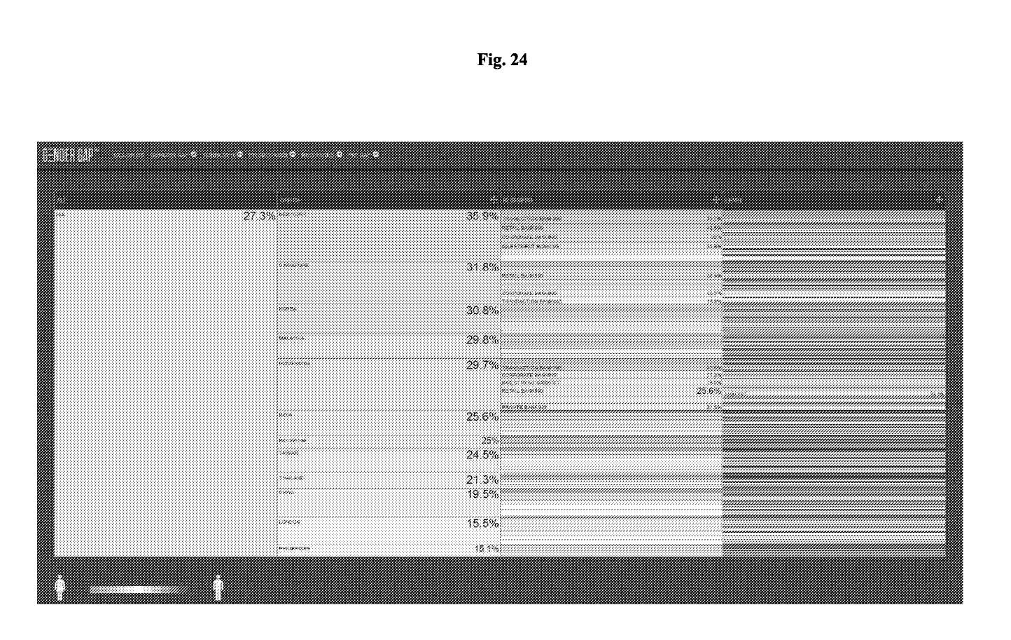

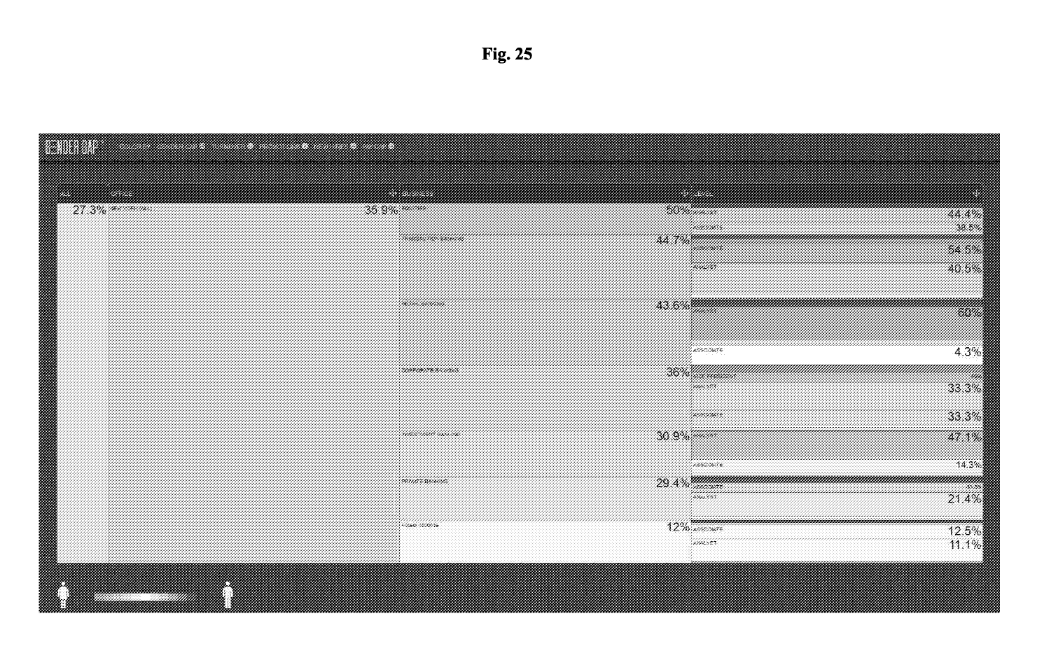

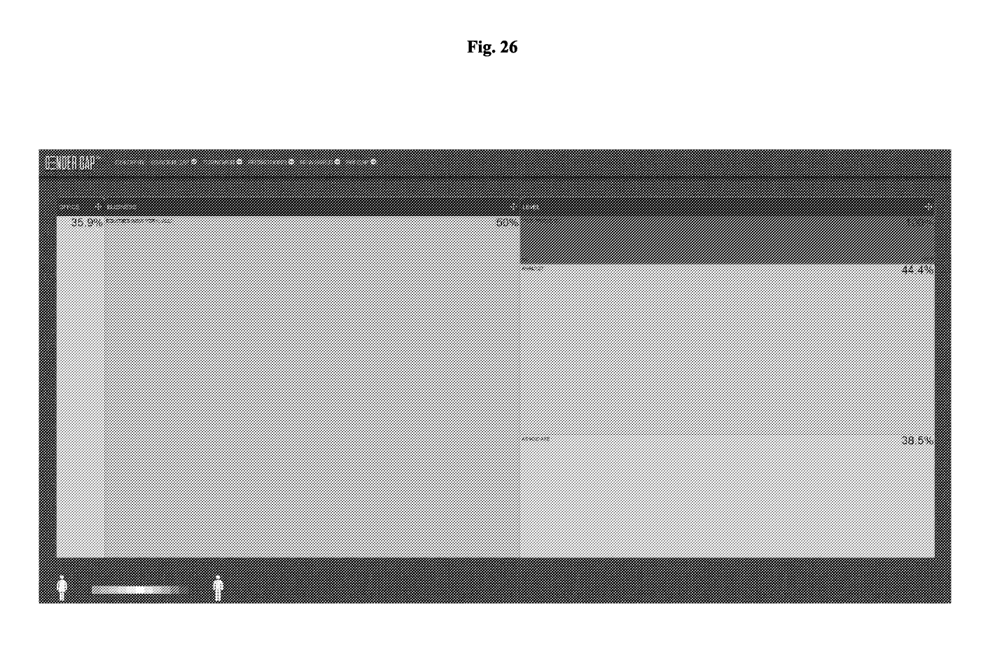

Referring to FIGS. 24-26, in particular embodiments, a human capital data display includes a live, interactive, heat map (e.g., partition) of gender compensation differences across divisions/units of the organization, levels within the organization, and locations in which the organization operates. In these embodiments, the heat map is interactive, allowing users to drill down into the data by clicking, touching, or otherwise interacting with the display. In these embodiments, a user is first presented a map partitioned by All, Office, Business, and Level (see FIG. 24). Clicking, for example, on Office/New York causes the map to transition to a view presenting data for the New York Office partitioned by Business and Level (see FIG. 25). Further clicking, for example, on Business/Equities causes the map to transition to a view presenting data for the New York Office Equities business partitioned by Level (see FIG. 26).

In some embodiments, the display of the data comprises a diversity score card. In further embodiments, a diversity score card provides a detailed summary of diversity parameters.

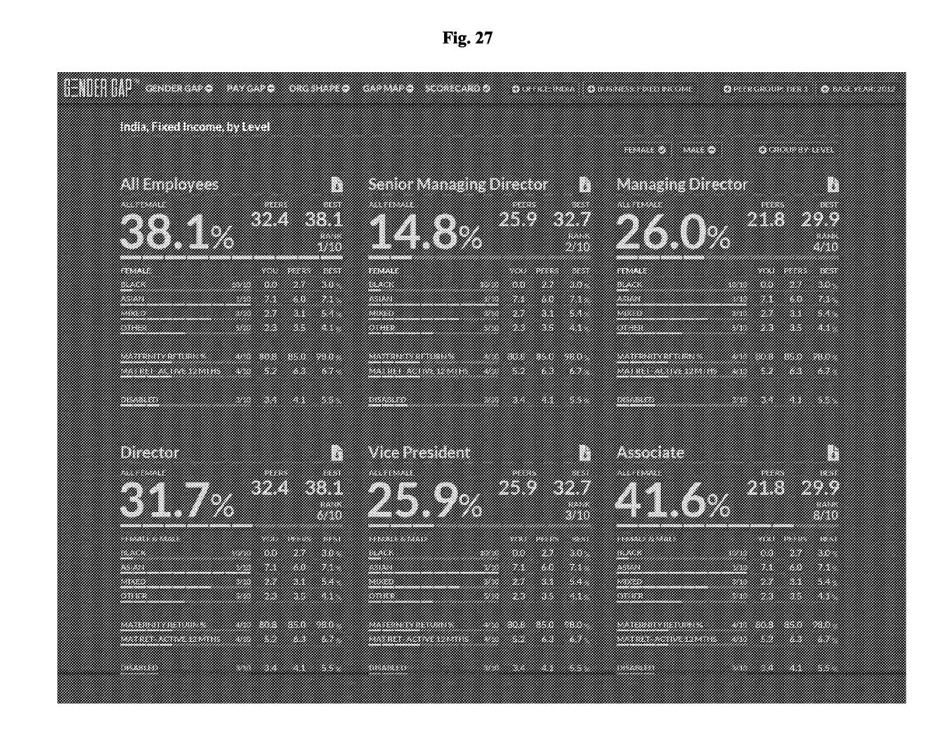

Referring to FIG. 27, in a particular embodiment, a human capital display includes a score card of human capital differences (e.g., disparities, inequalities, etc.) in the individuals of the organization. In this embodiment, a score card includes a visual summary of differences in gender, race/ethnicity, maternity, and disability for the organization in aggregate and at each level within the organization (e.g., associate, vice president, director, managing director, senior managing director, etc.). For each area of diversity, the score card includes percentage-based comparisons with organizational peer groups as well as numeric rankings Further in this embodiment, the data set summarized by the display is user-selectable and filters can be applied to limit data to one or more particular offices, one or more particular businesses, and/or one or more particular years.

### Comparators

In some embodiments, the systems, media, and methods described herein include benchmarking comparators, or use of the same. In further embodiments, a data display presents human capital data and further presents a comparison with a benchmark such as human capital data of a comparator organization. Many types of comparator organizations are suitable. In some embodiments, the comparator data comprises aggregate data of a peer group or organizations. In further embodiments, the peer group is user-selectable. In other embodiments, the peer group is selected based on the characteristics of the user organization. In other embodiments, the comparator data comprises data of a single organization. In some embodiments, the comparator data comprises data of a market leader. In further embodiments, the comparator organization is user-selectable. In other embodiments, the comparator organization is selected based on the characteristics of the user organization.

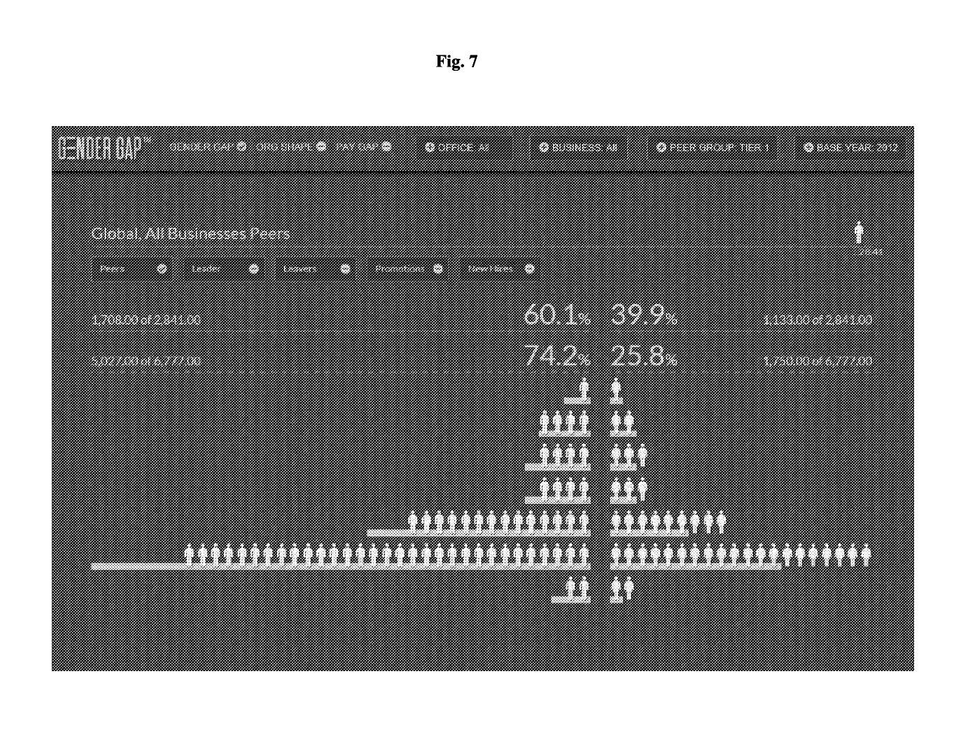

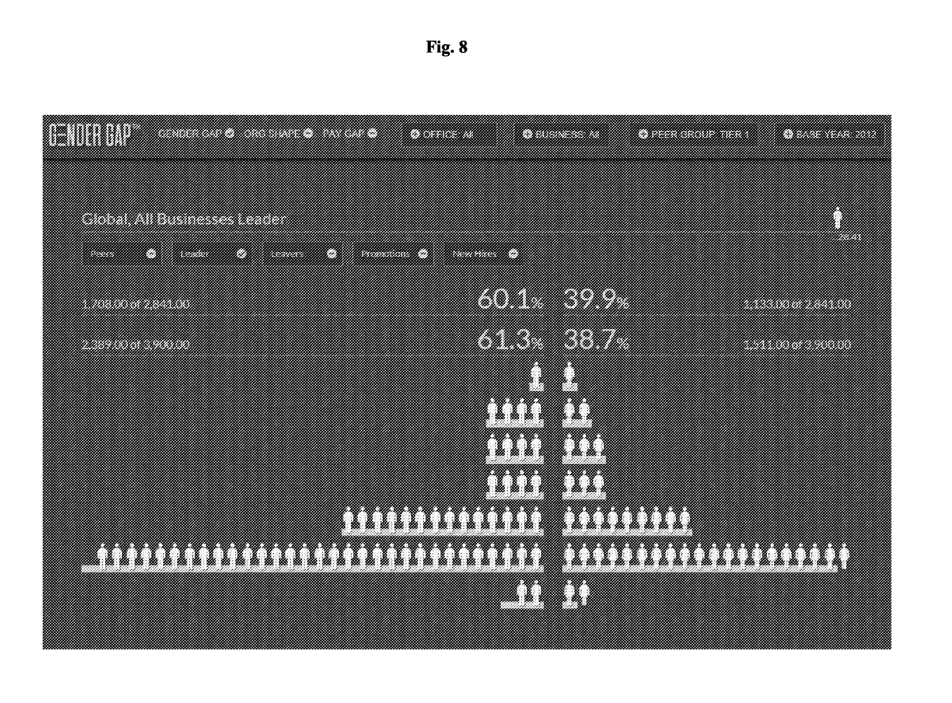

Referring to FIGS. 7 and 8, in particular embodiments, a human capital data display includes a comparison to a peer group of organizations (see FIG. 7) or an industry leader organization (see FIG. 8). In these embodiments, gender-based comparison to a peer or leader is provided graphically in the form of a horizontal bar for comparing gender data for each level within the organization and numerically in form of raw numbers and percentages.

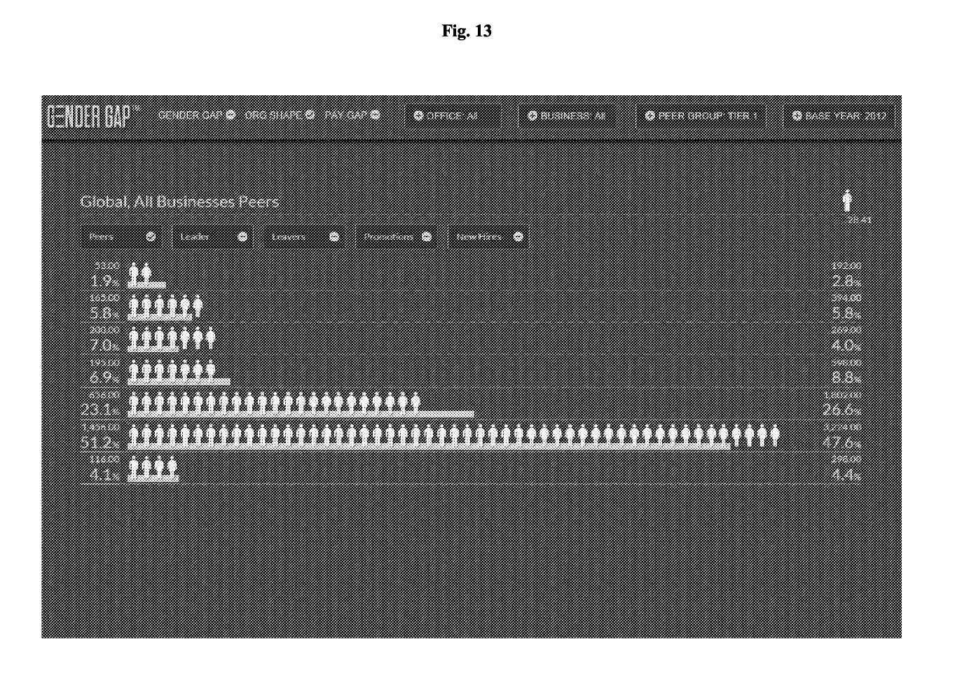

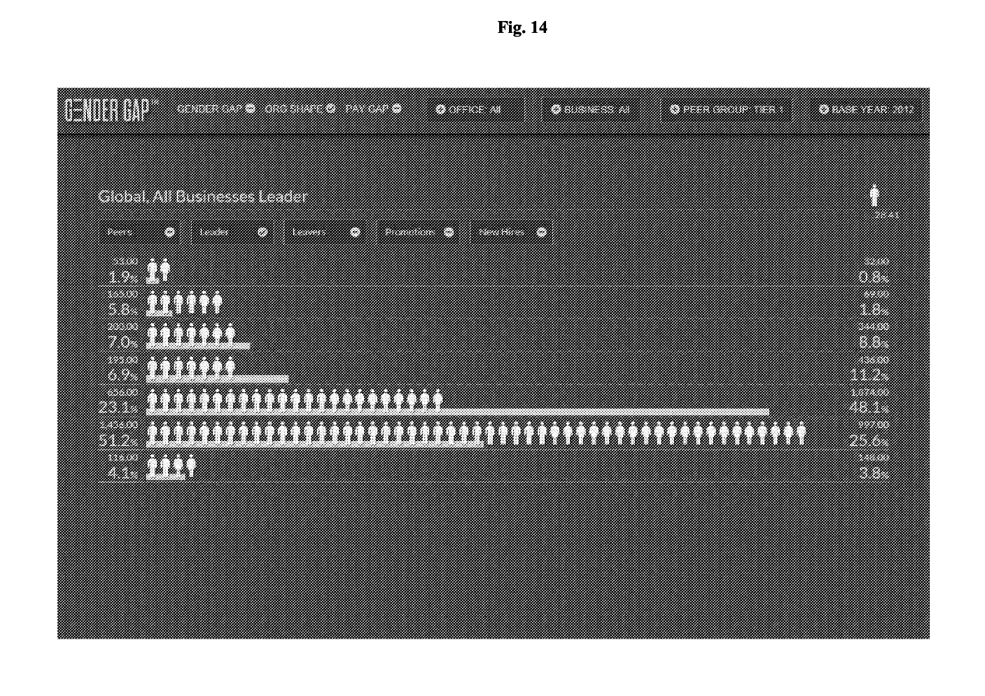

Referring to FIGS. 13 and 14, in particular embodiments, a gender profile of an organization includes a comparison to a peer group of organizations (see FIG. 13) or an industry leader organization (see FIG. 14). In these embodiments, gender-based comparison to a peer or leader is provided graphically in the form of a horizontal bar for comparing gender data for each level within the organization and numerically in form of raw numbers and percentages for each level within the organization.

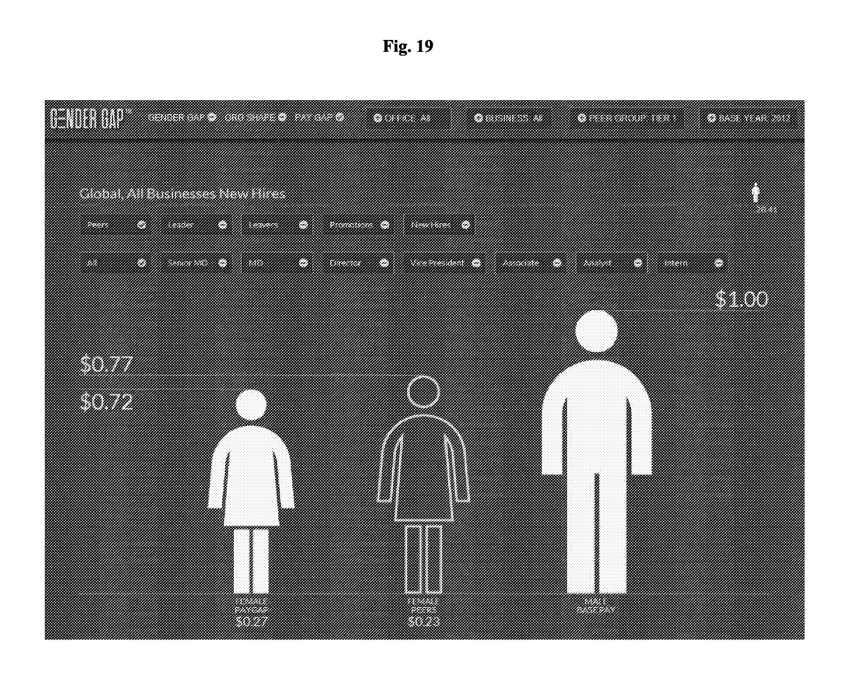

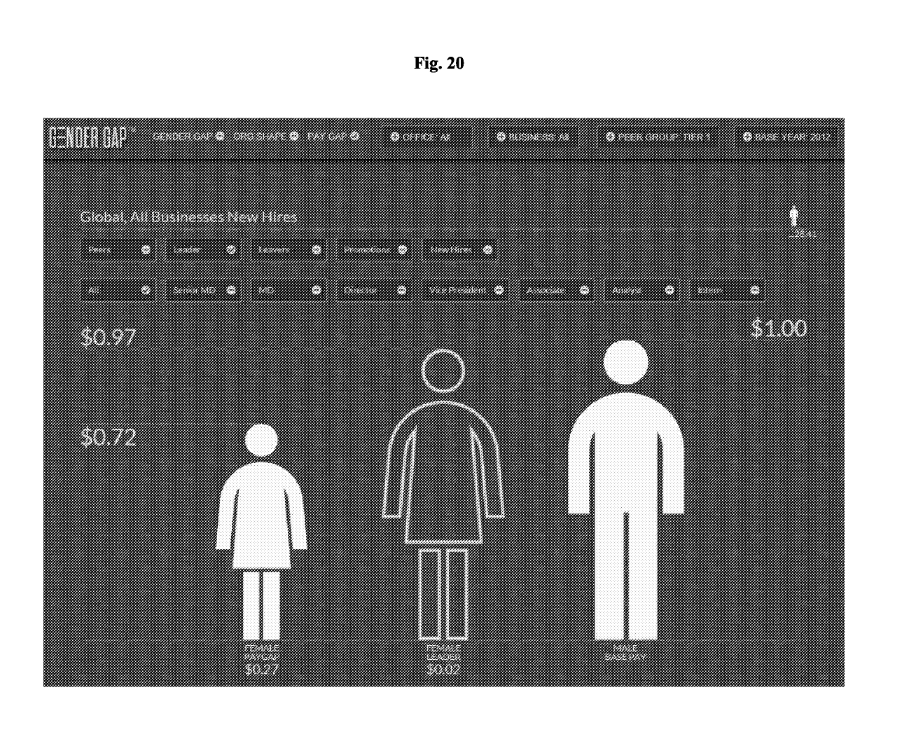

Referring to FIGS. 19 and 20, in particular embodiments, an overall gender pay gap of an organization includes a comparison to a peer group of organizations (see FIG. 19) or an industry leader organization (see FIG. 20). In these embodiments, gender-based comparison of compensation to a peer or leader is provided by way of icon size differences as well as numerically as dollar values.

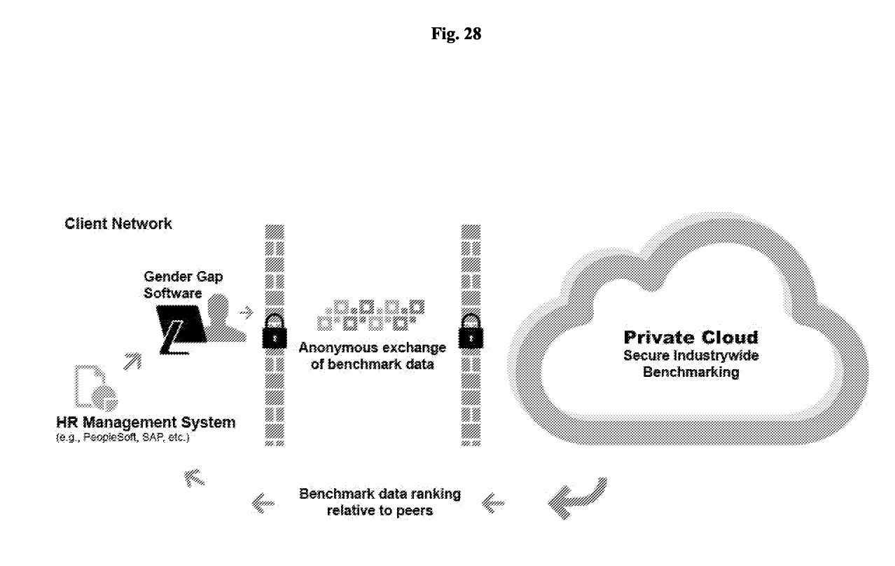

Referring to FIG. 28, in a particular embodiment, benchmarking comparators are exchanged anonymously via a private cloud. For example, in some cases the software described herein is deployed as enterprise software installed at the client. In such cases, the human capital data is never shared with the provider; however, clients can securely and anonymously exchange benchmarks via a private cloud.

### Bases of Diversity

The systems, media, and methods described are suitable to analyze, track, and summarize human capital data pertaining to many types of diversity. By way of example, in some embodiments, described herein are computer-implemented systems comprising: a digital processing device comprising an operating system configured to perform executable instructions and a memory device; a computer program including instructions executable by the digital processing device to create an application comprising: a software module configured to receive data input, the data comprising human capital data pertaining to individuals of an organization; a software module configured to tag the data pertaining to individuals with one or more diversity parameters; a software module configured to generate a display of the data, the display comprising comparison of the data based on diversity, the comparison in numeric and graphic form; and a software module configured to add comparator data to the display.

By way of example, in some embodiments, described herein are non-transitory computer-readable storage media encoded with a computer program including instructions executable by a processor to create an application comprising: a software module configured to receive data input, the data comprising human capital data pertaining to individuals of an organization; a software module configured to tag the data pertaining to individuals with one or more diversity indicators; a software module configured to generate a display of the data, the display comprising comparison of the data based on the diversity indicators, the comparison in numeric and graphic form; and a software module configured to add comparator data to the display.

In various embodiments, the systems, media, and methods described are suitable to analyze, track, and summarize types of diversity within an organization including, but not limited to, gender, age, ethnicity, nationality, religion or belief, sexual orientation, veteran status, marriage or civil partnership status, disability, part time/full time workers, caregiver status, pregnancy/maternity status, gender assignment (i.e., transgender), criminal conviction status, and trade union membership, including combinations thereof. In a particular embodiment, the systems, media, and methods described are suitable to analyze, track, and summarize gender differences in human capital data.

### Digital Processing Device

In some embodiments, the systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the systems, media, and methods disclosed herein include one or more databases, or use of the same. In view of the disclosure provided herein, those of skill in the art will recognize that many databases are suitable for storage and retrieval of human capital data. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. Non-transitory computer-readable storage media encoded with an interactive heat map, the heat map displaying a summary of human capital data for an organization, the human capital data tagged with at least one diversity parameter and partitioned into a hierarchical organization, wherein the hierarchical organization is ascended and descended via user interaction with the interactive heat map, provided that the heat map displays a human capital difference based on the at least one diversity parameter at each level of the hierarchical organization.

2. The media of claim 1, wherein the heat map is generated by:
a) receiving, by a computer, data input, the data comprising human capital data pertaining to individuals of an organization;
b) tagging, by the computer, the human capital data pertaining to individuals with at least one diversity parameter; and
c) generating, by the computer, a heat map display of the human capital data, the heat map comprising comparison of the human capital data based on the at least one diversity parameter, the comparison numeric and color-based.

3. The media of claim 1, wherein the heat map further comprises comparator data from one or more peer organizations or a leader organization.

4. Non-transitory computer-readable storage media encoded with a diversity score card for an organization, the diversity score card displaying a summary of human capital data for the organization, the human capital data tagged with at least one diversity parameter, wherein the diversity score card is configurable to be partitioned by location, unit of the organization, or level of individual within the organization, provided that the diversity score card displays at least one human capital difference based on the at least one diversity parameter for each partition including a comparison to human capital data of one or more comparator organizations.

5. The media of claim 4, wherein the diversity score card is generated by:
a) receiving, by a computer, data input, the data comprising human capital data pertaining to individuals of an organization;
b) tagging, by the computer, the human capital data pertaining to individuals with at least one diversity parameter; and
c) generating, by the computer, a score card display of the human capital data, the score card comprising comparison of the human capital data based on the at least one diversity parameter, the comparison comprising a percentage difference and a rank based on comparison to human capital data of one or more comparator organizations.

6. The media of claim 4, wherein the one or more comparator organizations comprises a peer organizations or a leader organization.

7. Non-transitory computer-readable storage media encoded with a computer program including instructions executable by a processor to create an application comprising:
a) a software module configured to receive data input, the data comprising human capital data pertaining to individuals of an organization;
b) a software module configured to tag the data pertaining to individuals with at least one diversity parameter;
c) a software module configured to generate a display of the data, the display comprising comparison of the data based on the at least one diversity parameter, the comparison in numeric and graphic form; and
d) a software module configured to add comparator data to the display.

8. The media of claim 7, wherein the at least one diversity parameter is selected from: gender, age, ethnicity, nationality, religion or belief, sexual orientation, veteran status, marriage or civil partnership status, disability, part time/full time workers, caregiver status, pregnancy/maternity status, gender assignment, criminal conviction status, and trade union membership.

9. The media of claim 8, wherein the at least one diversity parameter is gender.

10. The media of claim 7, wherein the human capital data comprises one or more of: human resources identifier, title, ethnicity, education, age, location, organization division or unit, year hired, entry point to organization, year left, promotion information, fixed compensation, bonus compensation, performance information, and maternity leave information.

11. The media of claim 10, wherein the human capital data comprises compensation data.

12. The media of claim 7, wherein the data input is provided by upload of an output from a human capital management application.

13. The media of claim 12, wherein the output is in a format selected from: a database, a spreadsheet, comma-separated values, and tab-separated values.

14. The media of claim 7, wherein the data input is provided by manual data entry.

15. The media of claim 7, wherein the display is based on data from one or more particular offices, one or more particular businesses, one or more particular years, or a combination thereof.

16. The media of claim 7, wherein the display of the data includes comparison of the data based on the at least one diversity parameter at each level within the organization.

17. The media of claim 7, wherein the display of the data includes comparison of the data based on the at least one diversity parameter and identifies one or more of: leavers, promotions, new hires, or combinations thereof.

18. The media of claim 7, wherein the comparison of the data based the at least one diversity parameter is presented in a numeric form selected from: a ratio, percentages for each gender, total numbers for each gender, or a combination thereof.

19. The media of claim 7, wherein the comparison of the data based the at least one diversity parameter is presented in a graphic form selected from: a graph, a chart, a table, or a combination thereof.

20. The media of claim 7, wherein the display of the data demonstrates diversity inequalities where present.

21. The media of claim 7, wherein the display of the data comprises a heat map of diversity differences.

22. The media of claim 7, wherein the comparator data comprises a peer group.

23. The media of claim 22, wherein the peer group is user-selectable.

24. The media of claim 7, wherein the comparator data comprises a market leader.

25. The media of claim 7, wherein the application is a web application.

26. The media of claim 25, wherein the web application is implemented as software-as-a-service.

27. A computer-implemented system comprising:
a) a digital processing device comprising an operating system configured to perform executable instructions and a memory device;
b) a computer program including instructions executable by the digital processing device to create an application comprising:
i) a software module configured to receive data input, the data comprising human capital data pertaining to individuals of an organization;
ii) a software module configured to tag the data pertaining to individuals with at least one diversity parameter;
iii) a software module configured to generate a display of the data, the display comprising comparison of the data based on the at least one diversity parameter, the comparison in numeric and graphic form; and
iv) a software module configured to add comparator data to the display.

28. The system of claim 27, wherein the at least one diversity parameter is selected from: gender, age, ethnicity, nationality, religion or belief, sexual orientation, veteran status, marriage or civil partnership status, disability, part time/full time workers, caregiver status, pregnancy/maternity status, gender assignment, criminal conviction status, and trade union membership.

29. The system of claim 28, wherein the at least one diversity parameter is gender.

30. The system of claim 27, wherein the human capital data comprises one or more of: human resources identifier, title, ethnicity, education, age, location, organization division or unit, year hired, entry point to organization, year left, promotion information, fixed compensation, bonus compensation, performance information, and maternity leave information.
